(19) United States
(12) Patent Application Publication
(10) Pub. No.: US 2009/0067151 A1
(43) Pub. Date: Mar. 12, 2009

(54) LIGHT GUIDE WITH FLEXIBILITY AND DURABILITY

(75) Inventors: JENNIFER J. SAHLIN, Minneapolis, MN (US); David J. Plaut, Minneapolis, MN (US); Kent S. Tarbutton, Lake Elmo, MN (US); David A. Ender, New Richmond, WI (US); Craig R. Sykora, New Richmond, WI (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/199,862

(22) Filed: Aug. 28, 2008

Related U.S. Application Data
(60) Provisional application No. 60/967,633, filed on Sep. 6, 2007.

(51) Int. Cl. G01D 11/28; F21V 11/00

(52) U.S. Cl. 362/23; 362/361

(57) ABSTRACT

A flexible light guide including a material having a tensile modulus of about 1 MPa to about 70 MPa, a T_{g} of about −5° C. to about 45° C., an absorbance in the visible spectrum of less than about 0.0279 cm⁻¹, a refractive index of about 1.35 to about 1.65, and a thickness of about 50 microns to about 700 microns.

### CROSS REFERENCE TO RELATED APPLICATION

This application claims the benefit of U.S. Provisional Patent Application No. 60/967,633, filed Sep. 6, 2007 the disclosure of which is incorporated by reference herein in its entirety.

### TECHNICAL FIELD

This disclosure relates to light guides. More specifically, this disclosure relates to light guides having desirable properties, such as flexibility and durability, for input devices including keypads.

### BACKGROUND

A variety of devices has been proposed for illuminating electronic displays and input devices such as keypads. These devices include backlighting panels, front lighting panels, concentrators, reflectors, structured-surface films, and other optical devices for redirecting, collimating, distributing, or otherwise manipulating light. Passive optical components (for example, lenses, prisms, mirrors, and light extraction structures) are well-known and are used in optical systems to collect, distribute, or modify optical radiation.

Efficient use of light is particularly important in battery powered electronic displays and keypads such as those used in cell phones, personal digital assistants, MP3 players and laptop computers. By improving lighting efficiency, battery life can be increased, power can be diverted to other electronic components, and/or battery sizes can be reduced, which is increasingly important as devices decrease in size and increase in functionality and complexity. Prismatic films are commonly used to improve lighting efficiency and enhance the apparent brightness of a backlit liquid crystal display, and multiple light sources (for example, light emitting diodes (LEDs)) are commonly used for this purpose in keypads.

Lighting quality is also an important consideration in electronic displays and keypads. One measure of lighting quality for a backlit display or keypad is brightness uniformity. Because displays (and, to a somewhat lesser extent, keypads) are typically studied closely or used for extended periods of time, relatively small differences in the brightness can easily be perceived. These types of variances in brightness can be distracting or annoying to a user. To soften or mask non-uniformities, a light scattering element (for example, a diffuser) can sometimes be used. However, such scattering elements can negatively affect the overall brightness of a display or keypad.

Alternatively, multiple light sources can be used to achieve brightness uniformity, but this approach has the associated disadvantage of reduced battery life. Thus, there has been some attention to the development of various means of effectively distributing the light from a more limited number of light sources, including the development of light guides comprising a plurality of light extraction structures. Such light extraction structures, as well as light extraction structure arrays, have been made by a number of different techniques and a variety of materials, each having a different set of strengths and weaknesses.

### SUMMARY

Further, light guides utilized in applications such as input devices may require additional properties. For example, in these applications it is generally desired that a user receives some form of feedback when a key or button is successfully depressed. A common form of feedback is tactile and/or audible feedback, such as a click or change in physical resistance detectable by a human finger when the key is successfully depressed.

In a typical backlit input device construction, the backlight emanates from a layer located between the keypad that a user interacts with and the electrical connection that is closed when the key is depressed. One solution which allows a backlit key to close the electrical connection when it is pushed is to provide an aperture in the backlight layer such that a protrusion on the side of the key facing the electrical connection may pass through the aperture when the key is depressed and close the electrical connection. However, when using a light guide to direct light from a small number of light sources (e.g. one or two LEDs), an aperture in the light guide may result in non-uniform illumination, which is one of the very problems the light guide is utilized to overcome.

Thus, it is appreciated that a light guide having properties that allow the effective transmission of force from a key to the electrical contact layer, while still providing uniform illumination of the individual keys, is needed.

Additionally, devices such as keypads are often used for relatively long periods of time, and each individual key may be pressed thousands or tens of thousands of times. Thus, a light guide is needed that not only possesses desired optical qualities, such as uniform illumination of the keypad, but also possesses sufficient durability to maintain both the optical qualities and the tactile feedback over the lifetime of the device in which the light guide is utilized.

In general, the disclosure relates to a light guide formed of a material possessing a combination of properties that allows the accomplishment of one or more of the above objectives.

In one aspect, the disclosure is directed to a flexible light guide comprising a material having a tensile modulus of from about 1 MPa to about 70 MPa at 23° C., an absorbance in the visible spectrum of less than about 0.0279 cm⁻¹, a refractive index of about 1.35 to about 1.65, and a thickness of from about 50 microns to about 700 microns, the light guide further comprising a plurality of light extraction structures. In some embodiments, the flexible light guide includes at least one light extraction structure that is a depression.

In another aspect, the disclosure is directed to a flexible light guide comprising a material having a dynamic bending modulus tensile modulus is from about 45 MPa to about 2500 MPa at 23° C., an absorbance of less than about 0.0132 cm⁻¹, a refractive index is about 1.45 to about 1.53, and a thickness of about 50 microns to about 700 microns, the light guide further comprising a plurality of light extraction structures. In some embodiments, the flexible light guide includes at least one light extraction structure that comprises a depression.

In another aspect, the disclosure is directed to a device including a keypad and a flexible light guide comprising a material having a tensile modulus of from about 1 MPa to about 70 MPa at 23° C., an absorbance in the visible spectrum of less than about 0.0279 cm⁻¹, a refractive index of about 1.35 to about 1.65, and a thickness of from about 50 microns to about 700 microns, the light guide further comprising a plurality of light extraction structures. In some embodiments, the flexible light guide includes at least one light extraction structure that comprises a depression.

In yet another aspect, the disclosure is directed to a method including providing a mold comprising a plurality of light extraction structures, contacting an uncured resin comprising at least one of acrylate, urethane, silicone, urethane-acrylate functional groups, and curing the uncured resin to form flexible light guide comprising a material having a tensile modulus of from about 1 MPa to about 70 MPa at 23° C., an absorbance in the visible spectrum of less than about 0.0279 cm⁻¹, a refractive index of about 1.35 to about 1.65, and a thickness of from about 50 microns to about 700 microns, the light guide further comprising a plurality of light extraction structures. In some embodiments, the flexible light guide includes at least one light extraction structure comprises a depression.

In yet another aspect, the disclosure is directed to a flexible light guide that includes at least one acrylate, wherein the tensile modulus is from about 1 MPa to about 20 MPa at 23° C., the absorbance in the visible spectrum is less than about 0.0203 cm⁻¹, the refractive index is from about 1.4 to about 1.55, and the thickness is from about 50 microns to about 700 microns, the light guide further comprising a plurality of light extraction structures. In some embodiments, the flexible light guide includes at least one light extraction structure comprises a depression.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a perspective view of a flexible light guide including a plurality of light extraction structure arrays.

FIGS. 2A-I are cross-sectional views of a variety of light extraction structures.

FIG. 3 is a flowchart illustrating an exemplary method of forming a flexible light guide.

FIG. 4 is a cross-sectional view illustrating a light guide used in a cell phone keypad assembly.

### DETAILED DESCRIPTION

Unless otherwise indicated, each number expressing feature sizes, amounts, and physical properties used in this document is to be understood as being modified in all instances by the term “about.” Accordingly, unless indicated to the contrary, the numerical parameters set forth in this document are approximations that can vary depending upon the desired properties sought to be obtained by those skilled in the art using the teachings disclosed herein. The use of numerical ranges by endpoints includes all numbers within that range (e.g. 1 to 5 includes 1, 1.5, 2, 2.75, 3, 3.80, 4, and 5) and any range within that range.

In general, the current disclosure is directed to light guides suitable for use in environments which require both flexibility and durability. One such environment includes input devices, and more specifically, keypads for cell phones, computers, MP3 players, and the like. Light guides suitable for use in these and similar applications preferably possess certain physical properties that do not detract from desirable tactile feedback during depression and/or release of a key, optical properties that allow the effective transmission of light, and sufficient durability to ensure both the tactile feedback and optical properties are substantially constant for the lifetime of the device.

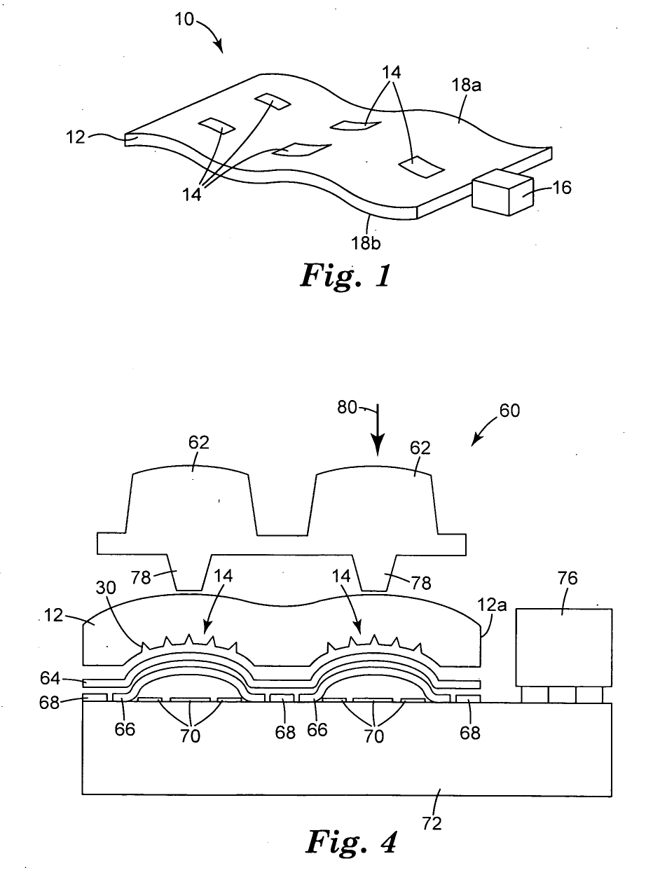

FIG. 1 is a perspective view illustrating a system 10 including a flexible light guide 12 and a light source 16. Flexible light guide 12 includes a plurality of light extraction structure arrays 14, each of which includes at least one light extraction structure. Flexible light guide 12 may be sufficiently flexible conform to a curved surface, such as a curved display screen or keypad. The flexibility of flexible light guide 12 may be affected by the properties of the materials that are used to form flexible light guide 12, including glass transition temperature (T_{g}) and tensile modulus, and by the thickness of flexible light guide 12.

Flexible light guide 12 preferably provides substantially homogeneous illumination in a direction substantially normal to surface 18a or 18b at each light extraction structure array 14. That is, in the case of a keypad, each key is illuminated substantially equally. This may be accomplished by combining geometries and fill factors such as those described hereinafter. Flexible light guide 12 preferably possesses substantially no birefringence and is substantially optically clear, so little visible light is lost to scattering or absorption. The combination of these properties may provide efficient use of light from light source 16.

Flexible light guide 12 directs light from at least one light source 16 and distributes the light through the flexible light guide 12 and emits the light via the light extraction structure arrays 14. The plurality of light extraction structure arrays 14 may reflect or refract light to direct light out of at least one of surfaces 18a, 18b of flexible light guide 12. Light extraction structure arrays 14 may be positioned continuously or intermittently throughout flexible light guide 12, depending on the desired illumination pattern. For example, when it is desired that only the keys on a cellular telephone keypad are illuminated, light extraction structure arrays 14 may be formed as islands on or in flexible light guide 12 which correspond to the locations of the keys, or which correspond to the shape of the respective numbers, letters, or symbols.

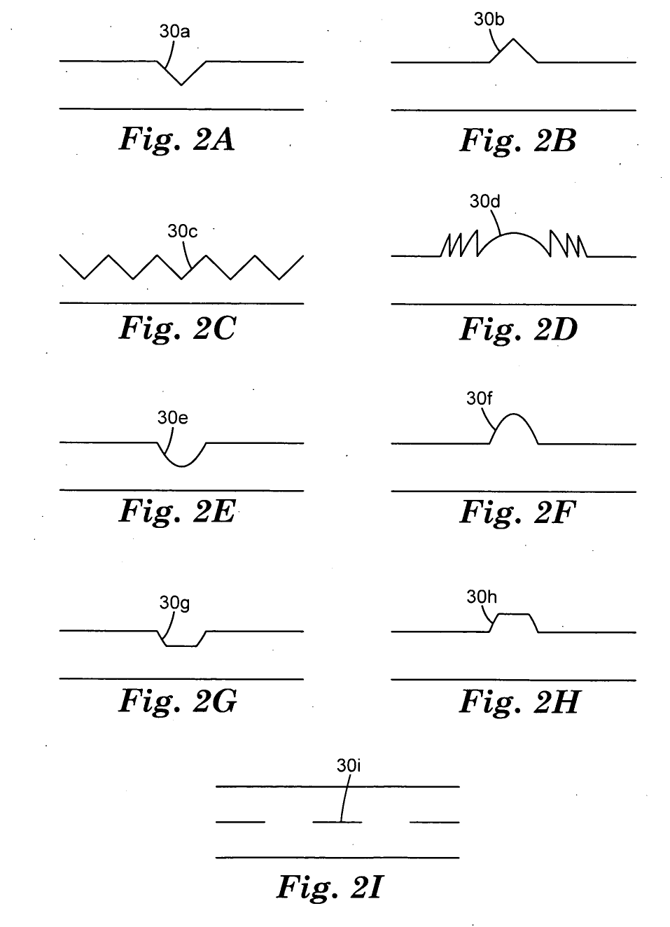

In some embodiments, light extraction structure arrays 14 may be located on a single major surface 18a or 18b of flexible light guide 12, or on both major surfaces 18a, 18b. Each individual light extraction structure 30 within light extraction structure arrays 14 may include depressions or protrusions, or both. For example, as shown in FIGS. 2A-2H, light extraction structures 30 may include a wide variety of geometries, including pyramid or cone shaped depressions 30a or protrusions 30b (FIGS. 2A and 2B), a repeating pattern of grooves 30c (FIG. 2C), Fresnel lenses 30d (FIG. 2D), prolate hemispheroid depressions 30e and protrusions 30f (FIGS. 2E and 2F), prolate hemispheroids with truncated ends 30g, 30h (FIGS. 2G and 2H), and the like.

In addition to the geometries shown in FIGS. 2A-2H, other geometries may be utilized. The configurations can be complex (for example, combining segments of multiple shapes in a single structure, such as a stacked combination of a cone and a pyramid or of a cone and a “Phillips head” shape). Geometric configurations can comprise such structural elements as a base, one or more faces (for example, that form a side wall), and a top (which can be, for example, a planar surface or even a point). Such elements can be of essentially any shape (for example, bases, faces, and tops can be circular, elliptical, or polygonal (regular or irregular), and the resulting side walls can be characterized by a vertical cross section (taken perpendicular to the base) that is parabolic, hyperbolic, or linear in nature, or a combination thereof). Preferably, the side wall is not perpendicular to the base of the structure (for example, angles of about 10 degrees to about 80 degrees (preferably, 20 to 70; more preferably, 30 to 60) can be useful). The light extraction structure can have a principal axis connecting the center of its top with the center of its base. Tilt angles (the angle between the principal axis and the base) of up to about 80 degrees (preferably, up to about 25 degrees) can be achieved, depending upon the desired brightness and field of view.

Alternatively to the geometric construction of light extraction structures 30, light extraction structures 30i may be printed onto or into flexible light guides 12 of the current disclosure, as in the example shown in FIG. 2I. For example, highly refractive or reflective inks may be printed onto flexible light guide 12, and the inks will cause light to refract or reflect similarly to encountering a geometrically formed surface between two materials of different refractive indices.

Individual light extraction structures 30 may have heights in the range of about 5 microns to about 300 microns (preferably, about 50 to about 200; more preferably, about 75 to about 150) and/or maximum lengths and/or maximum widths in the range of about 5 microns to about 500 microns (preferably, about 50 to about 300; more preferably, about 100 to about 300). Light extraction structure arrays 14, such as those illustrated in FIG. 1, may have a substantially homogeneous construction, i.e., all structures within a single array are similarly sized and shaped, or the size and shape of the light extraction structures 30 may vary substantially continuously or, alternatively, non-continuously, throughout a single light extraction structure array 14. Additionally, the fill factor of light extraction structures 30 (e.g. the number of light extraction structures per unit area) within a single light extraction structure array 14 may be substantially constant, or the fill factor may change throughout the light extraction structure array 14. For many applications, fill factors of about 1 percent to 100 percent (preferably, about 5 percent to 50 percent) can be useful. Similarly, light extraction structure 30 sizes, shapes, and fill factors may be substantially similar between light extraction structure arrays 14, or may vary either substantially continuously or non-continuously between light extraction structure arrays 14. Preferably, light extraction structure arrays 14 located further away from a light source 16 have light extraction structures 30 that are taller, have higher fill factors, or both, compared to light extraction structure arrays 14 closer to the light source 16.

As described briefly above, flexible light guide 12 is preferably substantially optically clear, and possesses substantially no birefringence, preferably no birefringence. Desired optical clarity may be determined to a sufficient accuracy by a theoretical calculation of a material's absorbance, and a measurement of the refractive index of the flexible light guide 12.

For example, the absorbance of the flexible light guide 12 may be calculated using Beer's law:

I/I₀=e^{αx} or α=−ln(I/I₀)/x

where I is the final intensity, I₀ is the incident intensity, α is the absorbance in cm⁻¹, and x is equal to the propagating path length, based on the dimensions of the light guide. To calculate the desired absorbance, a desired value of I/I₀, which relates the final intensity to the incident intensity is chosen, and the required absorbance to achieve this value (for a known path length) is calculated. Suitable flexible light guide 12 materials include those having an absorbance of less than about 0.0279 cm⁻¹, preferably less than about 0.0203 cm⁻¹, most preferably less than about 0.0132 cm⁻¹, which correspond to a 20% loss of light intensity, a 15% loss of light intensity or a 10% loss of light intensity, respectively, over a path length of about 8 cm.

Suitable flexible light guide 12 materials have a refractive index ranging from about 1.35 to about 1.65, preferably about 1.40 to about 1.55, most preferably from about 1.45 to about 1.53 within the visible spectrum (approximately 400 nm to 700 nm).

Flexible light guide 12 also preferably transmits force effectively so that tactile feedback is possible. For example, a common keypad construction includes metallic popples that deform when a key is pressed. The metallic popples make contact with an underlying circuit, which causes a processor to register a key press. Additionally, the popples give tactile and/or audible feedback when deformed, as the popple “pops” nearly inside-out. Flexible light guide 12 is typically located between the keypad and the popple layer, so any force applied to a key must be transmitted through the flexible light guide 12 to the popple. Thus, the flexible light guide 12 may be sufficiently flexible to allow deformation under loads typically applied by a user to a key, and yet sufficiently rigid to transmit this force to the popple and the tactile response of the popple back to the key. Construction of an input device will be further discussed hereinafter with reference to FIG. 4.

Flexible light guide 12 also preferably deforms substantially elastically under the loads applied to it. Specifically, both the individual light extraction structures 30 and the flexible light guide 12 preferably deform substantially elastically. It is important for durability and long life that flexible light guide 12 retains its original shape after deformation, particularly when flexible light guide 12 is utilized in an input device.

In addition to elastic deformation, other features may be included in the flexible light guide 12 to promote durability. For example, the individual light extraction structures 30 may be constructed as depressions. Light extraction structures 30 constructed in this manner may experience less deformation compared to light extraction structures 30 formed as protrusions when a key is depressed. Thus, flexible light guides 12 with depressed structures may exhibit enhanced durability.

Suitable materials for use in the flexible light guide 12 may vary widely, and essentially any polymeric material may be used, whether pre-polymerized and thermally formable, or polymerized thermally or radiation cured in contact with the mold. In some embodiments, thermally formable materials may be subsequently post-processed and crosslinked by a variety of processes such as, for example, e-beam or chemical curing. Exemplary materials include, but are not limited to, acrylates, urethanes, silicones, urethane acrylates, epoxies, thermoplastic materials, elastomers and the like. Materials may be chosen to accomplish one or more of the desired characteristics discussed above, such as flexibility (typically a function of T_{g}, tensile modulus, and thickness of the light guide), optical clarity (related to absorption and refractive index), and durability.

Reactive species suitable for use in the photoreactive compositions include both curable and non-curable species. Curable species are generally preferred and include, for example, addition-polymerizable monomers and oligomers and addition-crosslinkable polymers (such as free-radically polymerizable or crosslinkable ethylenically-unsaturated species including, for example, acrylates, methacrylates, and certain vinyl compounds such as styrenes), as well as cationically-polymerizable monomers and oligomers and cationically-crosslinkable polymers (which species are most commonly acid-initiated and which include, for example, epoxies, vinyl ethers, cyanate esters, etc.), and the like, and mixtures thereof.

Suitable ethylenically-unsaturated species are described, for example, by Palazzotto et al. in U.S. Pat. No. 5,545,676 at column 1, line 65, through column 2, line 26, and include mono-, di-, and poly-acrylates and methacrylates (for example, methyl acrylate, methyl methacrylate, ethyl acrylate, isopropyl methacrylate, n-hexyl acrylate, stearyl acrylate, allyl acrylate, glycerol diacrylate, glycerol triacrylate, ethyleneglycol diacrylate, diethyleneglycol diacrylate, triethyleneglycol dimethacrylate,1,3-propanediol diacrylate, 1,3-propanediol dimethacrylate, trimethylolpropane triacrylate, 1,2,4-butanetriol trimethacrylate, 1,4-cyclohexanediol diacrylate, pentaerythritol triacrylate, pentaerythritol tetraacrylate, pentaerythritol tetramethacrylate, sorbitol hexacrylate, bis[1-(2-acryloxy)]-p-ethoxyphenyldimethylmethane, bis [1-(3-acryloxy-2-hydroxy)]-p-propoxyphenyldimethylmethane, trishydroxyethyl-isocyanurate trimethacrylate, the bis-acrylates and bis-methacrylates of polyethylene glycols of molecular weight about 200-500, copolymerizable mixtures of acrylated monomers (such as those of U.S. Pat. No. 4,652,274, and acrylated oligomers such as those of U.S. Pat. No. 4, 642,126); unsaturated amides (for example, methylene bis-acrylamide, methylene bis-methacrylamide, 1,6-hexamethylene bis-acrylamide, diethylene triamine tris-acrylamide and beta-methacrylaminoethyl methacrylate); vinyl compounds (for example, styrene, diallyl phthalate, divinyl succinate, divinyl adipate, and divinyl phthalate); and the like; and mixtures thereof. Suitable reactive polymers include polymers with pendant (meth)acrylate groups, for example, having from 1 to about 50 (meth)acrylate groups per polymer chain. Examples of such polymers include aromatic acid (meth)acrylate half ester resins such as SARBOX resins available from Sartomer (for example, SARBOX 400, 401, 402, 404, and 405). Other useful reactive polymers curable by free radical chemistry include those polymers that have a hydrocarbyl backbone and pendant peptide groups with free-radically polymerizable functionality attached thereto, such as those described in U.S. Pat. No. 5,235,015 (Ali et al.). Mixtures of two or more monomers, oligomers, and/or reactive polymers can be used if desired. Preferred ethylenically-unsaturated species include acrylates, aromatic acid (meth)acrylate half ester resins, and polymers that have a hydrocarbyl backbone and pendant peptide groups with free-radically polymerizable functionality attached thereto.

Suitable cationically-reactive species are described, for example, by Oxman et al. in U.S. Pat. Nos. 5,998,495 and 6,025,406 and include epoxy resins. Such materials, broadly called epoxides, include monomeric epoxy compounds and epoxides of the polymeric type and can be aliphatic, alicyclic, aromatic, or heterocyclic. These materials generally have, on the average, at least 1 polymerizable epoxy group per molecule (preferably, at least about 1.5 and, more preferably, at least about 2). The polymeric epoxides include linear polymers having terminal epoxy groups (for example, a diglycidyl ether of a polyoxyalkylene glycol), polymers having skeletal oxirane units (for example, polybutadiene polyepoxide), and polymers having pendant epoxy groups (for example, a glycidyl methacrylate polymer or copolymer). The epoxides can be pure compounds or can be mixtures of compounds containing one, two, or more epoxy groups per molecule. These epoxy-containing materials can vary greatly in the nature of their backbone and substituent groups. For example, the backbone can be of any type and substituent groups thereon can be any group that does not substantially interfere with cationic cure at room temperature. Illustrative of permissible substituent groups include halogens, ester groups, ethers, sulfonate groups, siloxane groups, nitro groups, phosphate groups, and the like. The molecular weight of the epoxy-containing materials can vary from about 58 to about 100,000 or more.

Other epoxy-containing materials that are useful include glycidyl ether monomers of the formula:

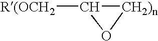

where R′ is alkyl or aryl and n is an integer of 1 to 8. Examples are glycidyl ethers of polyhydric phenols obtained by reacting a polyhydric phenol with an excess of a chlorohydrin such as epichlorohydrin (for example, the diglycidyl ether of 2,2-bis-(2,3-epoxypropoxyphenol)-propane). Additional examples of epoxides of this type are described in U.S. Pat. No. 3,018,262, and in Handbook of Epoxy Resins, Lee and Neville, McGraw-Hill Book Co., New York (1967).

A number of commercially available epoxy monomers or resins can be used. Epoxides that are readily available include, but are not limited to, octadecylene oxide; epichlorohydrin; styrene oxide; vinylcyclohexene oxide; glycidol; glycidyl methacrylate; diglycidyl ethers of bisphenol A (for example, those available as “EPON 815C”, “EPON 813”, “EPON 828”, “EPON 1004F”, and “EPON 1001F” from Hexion Specialty Chemicals, Inc., Columbus, Ohio); and diglycidyl ether of bisphenol F (for example, those available as “ARALDITE GY281” from Ciba Specialty Chemicals Holding Co., Basel, Switzerland, and “EPON 862” from Hexion Specialty Chemicals, Inc.). Other aromatic epoxy resins include the SU-8 resins available from MicroChem Corp., Newton, Mass.

Other exemplary epoxy monomers include vinyl cyclohexene dioxide (available from SPI Supplies, West Chester, Pa.); 4-vinyl-1-cylcohexene diepoxide (available from Aldrich Chemical Co., Milwaukee, Wis.); 3,4-epoxycyclohexylmethyl-3,4-epoxycyclohexene carboxylate (for example, one available as “CYRACURE UVR-6110” from Dow Chemical Co., Midland, Mich.); 3,4-epoxy-6-methylcylcohexylmethyl-3,4-epoxy-6-methyl-cylcohexane carboxylate; 2-(3,4-epoxycyclohexyl-5,5-spiro-3,4-epoxy) cyclohexane-metadioxane; bis(3,4-epoxycyclohexylmethyl) adipate (for example, one available as “CYRACURE UVR-6128” from Dow Chemical Co.); bis(3,4-epoxy-6-methylclyclohexylmethyl)adipate; 3,4-epoxy-6-methylcyclohexane carboxylate; and dipentene dioxide.

Still other exemplary epoxy resins include epoxidized polybutadiene (for example, one available as “POLY BD 605E” from Sartomer Co., Inc., Exton, Pa.); epoxy silanes (for example, 3,4-epoxycylclohexylethyltrimethoxysilane and 3-glycidoxypropyltrimethoxysilane, available from Aldrich Chemical Co., Milwaukee, Wis.); flame retardant epoxy monomers (for example, one available as “DER-542”, a brominated bisphenol type epoxy monomer available from Dow Chemical Co., Midland, Mich.); 1,4-butanediol diglycidyl ether (for example, one available as “ARALDITE RD-2” from Ciba Specialty Chemicals); hydrogenated bisphenol A-epichlorohydrin based epoxy monomers (for example, one available as “EPONEX 1510” from Hexion Specialty Chemicals, Inc.); polyglycidyl ether of phenol-formaldehyde novolak (for example, one available as “DEN-431” and “DEN-438” from Dow Chemical Co.); and epoxidized vegetable oils such as epoxidized linseed and soybean oils available as “VIKOLOX” and “VIKOFLEX” from Atofina Chemicals (Philadelphia, Pa.).

Additional suitable epoxy resins include alkyl glycidyl ethers available from Hexion Specialty Chemicals, Inc. (Columbus, Ohio) under the trade designation “HELOXY”. Exemplary monomers include “HELOXY MODFIER 7” (a C₈-C₁₀ alky glycidyl ether), “HELOXY MODIFIER 8” (a C₁₂-C₁₄ alkyl glycidyl ether), “HELOXY MODIFIER 61” (butyl glycidyl ether), “HELOXY MODIFER 62” (cresyl glycidyl ether), “HELOXY MODIFER 65” (p-tert-butylphenyl glycidyl ether), “HELOXY MODIFER 67” (diglycidyl ether of 1,4-butanediol), “HELOXY 68” (diglycidyl ether of neopentyl glycol), “HELOXY MODIFER 107” (diglycidyl ether of cyclohexanedimethanol), “HELOXY MODIFER 44” (trimethylol ethane triglycidyl ether), “HELOXY MODIFIER 48” (trimethylol propane triglycidyl ether), “HELOXY MODIFER 84” (polyglycidyl ether of an aliphatic polyol), and “HELOXY MODIFER 32” (polyglycol diepoxide).

Other useful epoxy resins comprise copolymers of acrylic acid esters of glycidol (such as glycidyl acrylate and glycidyl methacrylate) with one or more copolymerizable vinyl compounds. Examples of such copolymers are 1:1 styrene-glycidyl methacrylate and 1:1 methyl methacrylate-glycidyl acrylate. Other useful epoxy resins are well known and contain such epoxides as epichlorohydrins, alkylene oxides (for example, propylene oxide), styrene oxide, alkenyl oxides (for example, butadiene oxide), and glycidyl esters (for example, ethyl glycidate).

Useful epoxy-functional polymers include epoxy-functional silicones such as those described in U.S. Pat. No. 4,279,717 (Eckberg et al.), which are available from the General Electric Company. These are polydimethylsiloxanes in which 1-20 mole % of the silicon atoms have been substituted with epoxyalkyl groups (preferably, epoxy cyclohexylethyl, as described in U.S. Pat. No. 5,753,346 (Leir et al.).

Blends of various epoxy-containing materials can also be utilized. Such blends can comprise two or more weight average molecular weight distributions of epoxy-containing compounds (such as low molecular weight (below 200), intermediate molecular weight (about 200 to 1000), and higher molecular weight (above about 1000)). Alternatively or additionally, the epoxy resin can contain a blend of epoxy-containing materials having different chemical natures (such as aliphatic and aromatic) or functionalities (such as polar and non-polar). Other cationically-reactive polymers (such as vinyl ethers and the like) can additionally be incorporated, if desired.

Preferred epoxies include aromatic glycidyl epoxies (for example, the EPON resins available from Hexion Specialty Chemicals, Inc. and the SU-8 resins available from MicroChem Corp., Newton, Mass., including XP KMPR 1050 strippable SU-8), and the like, and mixtures thereof. More preferred are the SU-8 resins and mixtures thereof.

Suitable cationally-reactive species also include vinyl ether monomers, oligomers, and reactive polymers (for example, methyl vinyl ether, ethyl vinyl ether, tert-butyl vinyl ether, isobutyl vinyl ether, triethyleneglycol divinyl ether (RAPI-CURE DVE-3, available from International Specialty Products, Wayne, N.J.), trimethylolpropane trivinyl ether, and the VECTOMER divinyl ether resins from Morflex, Inc., Greensboro, N.C. (for example, VECTOMER 1312, VECTOMER 4010, VECTOMER 4051, and VECTOMER 4060 and their equivalents available from other manufacturers)), and mixtures thereof. Blends (in any proportion) of one or more vinyl ether resins and/or one or more epoxy resins can also be utilized. Polyhydroxy-functional materials (such as those described, for example, in U.S. Pat. No. 5,856,373 (Kaisaki et al.)) can also be utilized in combination with epoxy- and/or vinyl ether-functional materials.

Non-curable species include, for example, reactive polymers whose solubility can be increased upon acid- or radical-induced reaction. Such reactive polymers include, for example, aqueous insoluble polymers bearing ester groups that can be converted by photogenerated acid to aqueous soluble acid groups (for example, poly(4-tert-butoxycarbonyloxystyrene). Non-curable species also include the chemically-amplified photoresists described by R. D. Allen, G. M. Wallraff, W. D. Hinsberg, and L. L. Simpson in “High Performance Acrylic Polymers for Chemically Amplified Photoresist Applications,” J. Vac. Sci. Technol. B, 9, 3357 (1991). The chemically-amplified photoresist concept is now widely used for microchip manufacturing, especially with sub-0.5 micron (or even sub-0.2 micron) features. In such photoresist systems, catalytic species (typically hydrogen ions) can be generated by irradiation, which induces a cascade of chemical reactions. This cascade occurs when hydrogen ions initiate reactions that generate more hydrogen ions or other acidic species, thereby amplifying reaction rate. Examples of typical acid-catalyzed chemically-amplified photoresist systems include deprotection (for example, t-butoxycarbonyloxystyrene resists as described in U.S. Pat. No. 4,491,628, tetrahydropyran (THP) methacrylate-based materials, THP-phenolic materials such as those described in U.S. Pat. No. 3,779,778, t-butyl methacrylate-based materials such as those described by R. D Allen et al. in Proc. SPIE 2438, 474 (1995), and the like); depolymerization (for example, polyphthalaldehyde-based materials); and rearrangement (for example, materials based on the pinacol rearrangements).

If desired, mixtures of different types of reactive species can be utilized in the photoreactive compositions. For example, mixtures of free-radically-reactive species and cationically-reactive species are also useful.

Suitable photoinitiators (that is, electron acceptor compounds) for the reactive species of the photoreactive compositions include iodonium salts (for example, diaryliodonium salts), sulfonium salts (for example, triarylsulfonium salts optionally substituted with alkyl or alkoxy groups, and optionally having 2,2′ oxy groups bridging adjacent aryl moieties), and the like, and mixtures thereof.

The photoinitiator is preferably soluble in the reactive species and is preferably shelf-stable (that is, does not spontaneously promote reaction of the reactive species when dissolved therein). Accordingly, selection of a particular photoinitiator can depend to some extent upon the particular reactive species chosen, as described above. If the reactive species is capable of undergoing an acid-initiated chemical reaction, then the photoinitiator is an onium salt (for example, an iodonium or sulfonium salt).

Suitable iodonium salts include those described by Palazzotto et al. in U.S. Pat. No. 5,545,676 at column 2, lines 28 through 46. Suitable iodonium salts are also described in U.S. Pat. Nos. 3,729,313, 3,741,769, 3,808,006, 4,250,053 and 4,394,403. The iodonium salt can be a simple salt (for example, containing an anion such as Cl⁻, Br⁻, I⁻ or C₄H₅ SO₃⁻) or a metal complex salt (for example, containing SbF₆⁻, PF₆⁻, BF₄⁻, tetrakis(perfluorophenyl)borate, SbF₅OH⁻ or AsF₆⁻). Mixtures of iodonium salts can be used if desired.

Examples of useful aromatic iodonium complex salt photoinitiators include diphenyliodonium tetrafluoroborate; di(4-methylphenyl)iodonium tetrafluoroborate; phenyl-4-methylphenyliodonium tetrafluoroborate; di(4-heptylphenyl)iodonium tetrafluoroborate; di(3-nitrophenyl)iodonium hexafluorophosphate; di(4-chlorophenyl)iodonium hexafluorophosphate; di(naphthyl)iodonium tetrafluoroborate; di(4-trifluoromethylphenyl)iodonium tetrafluoroborate; diphenyliodonium hexafluorophosphate; di(4-methylphenyl)iodonium hexafluorophosphate; diphenyliodonium hexafluoroarsenate; di(4-phenoxyphenyl)iodonium tetrafluoroborate; phenyl-2-thienyliodonium hexafluorophosphate; 3,5-dimethylpyrazolyl-4-phenyliodonium hexafluorophosphate; diphenyliodonium hexafluoroantimonate; 2,2′-diphenyliodonium tetrafluoroborate; di(2,4-dichlorophenyl)iodonium hexafluorophosphate; di(4-bromophenyl)iodonium hexafluorophosphate; di(4-methoxyphenyl)iodonium hexafluorophosphate; di(3-carboxyphenyl)iodonium hexafluorophosphate; di(3-methoxycarbonylphenyl)iodonium hexafluorophosphate; di(3-methoxysulfonylphenyl)iodonium hexafluorophosphate; di(4-acetamidophenyl)iodonium hexafluorophosphate; di(2-benzothienyl)iodonium hexafluorophosphate; and diphenyliodonium hexafluoroantimonate; and the like; and mixtures thereof. Aromatic iodonium complex salts can be prepared by metathesis of corresponding aromatic iodonium simple salts (such as, for example, diphenyliodonium bisulfate) in accordance with the teachings of Beringer et al., J. Am. Chem. Soc. 81, 342 (1959).

Preferred iodonium salts include diphenyliodonium salts (such as diphenyliodonium chloride, diphenyliodonium hexafluorophosphate, and diphenyliodonium tetrafluoroborate), diaryliodonium hexafluoroantimonate (for example, SarCat™ SR 1012 available from Sartomer Company), and mixtures thereof.

Useful sulfonium salts include those described in U.S. Pat. No. 4,250,053 (Smith) at column 1, line 66, through column 4, line 2, which can be represented by the formulas:

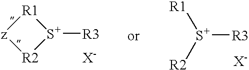

wherein R₁, R₂, and R₃ are each independently selected from aromatic groups having from about 4 to about 20 carbon atoms (for example, substituted or unsubstituted phenyl, naphthyl, thienyl, and furanyl, where substitution can be with such groups as alkoxy, alkylthio, arylthio, halogen, and so forth) and alkyl groups having from 1 to about 20 carbon atoms. As used here, the term “alkyl” includes substituted alkyl (for example, substituted with such groups as halogen, hydroxy, alkoxy, or aryl). At least one of R₁, R₂, and R₃ is aromatic, and, preferably, each is independently aromatic. Z is selected from the group consisting of a covalent bond, oxygen, sulfur, —S(═O)—, —C(═O)—, —(O═)S(═O)—, and —N(R)—, where R is aryl (of about 6 to about 20 carbons, such as phenyl), acyl (of about 2 to about 20 carbons, such as acetyl, benzoyl, and so forth), a carbon-to-carbon bond, or —(R₄—)C(—R₅)—, where R₄ and R₅ are independently selected from the group consisting of hydrogen, alkyl groups having from 1 to about 4 carbon atoms, and alkenyl groups having from about 2 to about 4 carbon atoms. X⁻ is an anion, as described below.

Suitable anions, X⁻, for the sulfonium salts (and for any of the other types of photoinitiators) include a variety of anion types such as, for example, imide, methide, boron-centered, phosphorous-centered, antimony-centered, arsenic-centered, and aluminum-centered anions.

Illustrative, but not limiting, examples of suitable imide and methide anions include (C₂F₅SO₂)₂N⁻, (C₄F₉SO₂)₂N⁻, (C₈F₁₇SO₂)₃C⁻, (CF₃SO₂)₃C⁻, (CF₃SO₂)₂N⁻, (C₄F₉SO₂)₃C⁻, (CF₃SO₂)₂(C₄F₉SO₂)C⁻, (CF₃SO₂)(C₄F₉SO₂)N⁻, ((CF₃)₂NC₂F₄SO₂)₂N⁻, (CF₃)₂NC₂F₄SO₂C⁻(SO₂CF₃)₂, (3,5-bis(CF₃)C₆H₃)SO₂N⁻SO₂CF₃, C₆H₅SO₂C⁻(SO₂CF₃)₂, C₆H₅SO₂N⁻SO₂CF₃, and the like. Preferred anions of this type include those represented by the formula (R_{f}SO₂)₃C⁻, wherein R_{f} is a perfluoroalkyl radical having from 1 to about 4 carbon atoms.

Illustrative, but not limiting, examples of suitable boron-centered anions include F₄B⁻, (3,5-bis(CF₃)C₆H₃)₄B⁻, (C₆F₅)₄B⁻, (p-CF₃C₆H₄)₄B⁻, (m-CF₃C₆H₄)₄B⁻, (p-FC₆H₄)₄B⁻, (C₆F₅)₃(CH₃)B⁻, (C₆F₅)₃(n-C₄H₉)B⁻, (p-CH₃C₆H₄)₃(C₆F₅)B⁻, (C₆F₅)₃FB⁻, (C₆H₅)₃(C₆F₅)B⁻, (CH₃)₂(p-CF₃C₆H₄)₂B⁻, (C₆F₅)₃(n-C₁₈H₃₇O)B⁻, and the like. Preferred boron-centered anions generally contain 3 or more halogen-substituted aromatic hydrocarbon radicals attached to boron, with fluorine being the most preferred halogen. Illustrative, but not limiting, examples of the preferred anions include (3,5-bis(CF₃)C₆H₃)₄B⁻, (C₆F₅)₄B⁻, (C₆F₅)₃(n-C₄H₉)B⁻, (C₆F₅)₃FB⁻, and (C₆F₅)₃(CH₃)B⁻.

Suitable anions containing other metal or metalloid centers include, for example, (3,5-bis(CF₃)C₆H₃)₄Al⁻, (C₆F₅)₄Al⁻, (C₆F₅)₂F₄P⁻, (C₆F₅)F₅P⁻, F₆P⁻, (C₆F₅)F₅Sb⁻, F₆Sb⁻, (HO)F₅Sb⁻, and F₆As⁻. The foregoing lists are not intended to be exhaustive, as other useful boron-centered nonnucleophilic salts, as well as other useful anions containing other metals or metalloids, will be readily apparent (from the foregoing general formulas) to those skilled in the art.

Preferably, the anion, X⁻, is selected from tetrafluoroborate, hexafluorophosphate, hexafluoroarsenate, hexafluoroantimonate, and hydroxypentafluoroantimonate (for example, for use with cationically-reactive species such as epoxy resins).

Examples of suitable sulfonium salt photoinitiators include:

triphenylsulfonium tetrafluoroborate

methyldiphenylsulfonium tetrafluoroborate

dimethylphenylsulfonium hexafluorophosphate

triphenylsulfonium hexafluorophosphate

triphenylsulfonium hexafluoroantimonate

diphenylnaphthylsulfonium hexafluoroarsenate

tritolysulfonium hexafluorophosphate

anisyldiphenylsulfonium hexafluoroantimonate

4-butoxyphenyldiphenylsulfonium tetrafluoroborate

4-chlorophenyldiphenylsulfonium hexafluorophosphate

tri(4-phenoxyphenyl)sulfonium hexafluorophosphate

di(4-ethoxyphenyl)methylsulfonium hexafluoroarsenate

4-acetonylphenyldiphenylsulfonium tetrafluoroborate

4-thiomethoxyphenyldiphenylsulfonium hexafluorophosphate

di(methoxysulfonylphenyl)methylsulfonium hexafluoroantimonate

di(nitrophenyl)phenylsulfonium hexafluoroantimonate

di(carbomethoxyphenyl)methylsulfonium hexafluorophosphate

4-acetamidophenyldiphenylsulfonium tetrafluoroborate

dimethylnaphthylsulfonium hexafluorophosphate

trifluoromethyldiphenylsulfonium tetrafluoroborate

p-(phenylthiophenyl)diphenylsulfonium hexafluoroantimonate

10-methylphenoxathiinium hexafluorophosphate

5-methylthianthrenium hexafluorophosphate

10-phenyl-9,9-dimethylthioxanthenium hexafluorophosphate

10-phenyl-9-oxothioxanthenium tetrafluoroborate

5-methyl-10-oxothianthrenium tetrafluoroborate

5-methyl-10,10-dioxothianthrenium hexafluorophosphate

Preferred sulfonium salts include triaryl-substituted salts such as triarylsulfonium hexafluoroantimonate (for example, SARCAT SR1010 available from Sartomer Company), triarylsulfonium hexafluorophosphate (for example, SARCAT SR 1011 available from Sartomer Company), and triarylsulfonium hexafluorophosphate (for example, SARCAT KI85 available from Sartomer Company).

Preferred photoinitiators include iodonium salts (more preferably, aryliodonium salts), sulfonium salts, and mixtures thereof. More preferred are aryliodonium salts and mixtures thereof.

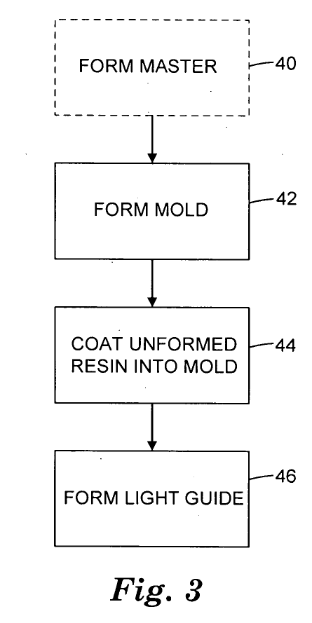

FIG. 3 is a flow chart illustrating an exemplary method of forming a flexible light guide 12. First, and optionally, a master is formed (40). The master may be formed by any one of a number of processes, including multiphoton curing, laser etching, chemical etching, diamond turned machining, and the like. A presently preferred process includes multiphoton curing, as described more completely in currently pending PCT Publication No. 2007/137,102 (Martilla et al.), which is incorporated herein by reference in its entirety. Multiphoton curing allows for the fabrication of complex three dimensional structures through the scanning of the curing light. Because the probability of photon absorption is proportional to the intensity of the light beam squared in two photon processes, and corresponding higher powers in three or four photon processes, curing may be confined to relatively small voxels. The composition can optionally be developed by removing the resulting exposed portion, or the resulting non-exposed portion, of the composition. Multiphoton curing may be conveniently used to produce light extraction structure arrays 14 that include light extraction structures 30 that vary in geometry or fill factor throughout the array.

A mold may be formed (42) from the master, or may be formed directly. For example, the mold may be formed directly using chemical etching of silicon, laser etching of a metal, diamond turned machining, and the like.

Alternatively, the mold may be formed (42) as a negative of the master. This may be accomplished by electroforming the master, or by molding another material, such as a silicone, a fluoropolymer or an olefin, over the master. A radiation-curable resin can also be used.

Additionally, there may be intermediate steps between forming the master (40) and forming the mold (42). For example, a master may be formed by multiphoton curing to be a negative of the desired final structure. The master may then be electroformed to give a positive mold, over which silicone is molded to give the final mold, which is used to replicate the desired flexible light guide 12.

The final mold, i.e., the mold used to produce the flexible light guides 12, may be either flexible or rigid, as is apparent from the discussion above. The mold may comprise nickel or another metal that is compatible with an electroforming process, or the mold may include a polymeric material, for example, silicone, olefin, fluoropolymer, and the like. The mold is preferably used for mass-production of the flexible light guides 12, so durability is an important factor to consider when making the mold.

In using the mold for making flexible light guides 12, unformed resin is first brought into contact with the mold (44). The unformed resin may be uncured polymer precursors, such as acrylates, silicones, urethanes and the like, or may be a thermoplastic material above its softening point or melting point. The mold may be filled with unformed resin by, for example, pouring the resin into the mold, injection molding, coating processes, and the like. Alternatively, the mold may be brought into contact with, for example, a sheet of uncured resin in a batch or continuous process. Once the resin and mold are in close contact, the unformed resin is formed (46), either by curing or by cooling, in the cases of uncured polymer precursors and thermoplastics, respectively. The formed resin is then removed from the mold and any finishing needed, such as cutting off edges, is performed.

As described briefly above, flexible light guides 12 of the current disclosure may be used in a system to provide backlight to an input device. FIG. 4 is a cross-sectional view illustrating an embodiment of the flexible light guide being utilized in a cellular telephone keypad assembly 60. Flexible light guide 12 is located between a plurality of keys 62 and domesheet 64, with one end adjacent a side-emitting LED 7. Flexible light guide 12 also includes a plurality of light extraction structure arrays 14, each of which includes a plurality of light extraction structures 30. Each light extraction structure array 14 is located underneath a corresponding key 62, and directs light to the key 62. Domesheet 64 covers conductive popples 66 and spacer adhesives 68.

When a user depresses a key 62 (arrow 80), the corresponding protrusion 78 is also pushed down and contacts a portion of flexible light guide 12 adjacent protrusion 78. As the user continues to further depress key 62, the flexible light guide 12 deforms and contacts the domesheet 64, which also deforms. Domesheet 64 contacts the adjacent popple 66, which is deformed and “pops” when at least a portion of popple 66 is pushed inside out. This causes the tactile feedback, and also causes at least a portion of popple 66 to contact at least a portion of electrical contacts 70. This contact closes the electronic circuit and is interpreted as a key press. Thus, as described above, the preferred flexible light guide 12 transmits the force applied to key 62 effectively to popple 66 so that popple 66 “pops” and makes electrical contact with electrical contacts 70.

### EXAMPLES

### Preparation of Silicone Mold

A nickel master was first prepared by electroforming a two photon master. Uncured silicone (300 g) and a catalyst (30 g), available as TC-5045 A/B from BJB Enterprises, Inc., Tustin, Calif., were mixed for approximately 5 minutes until the mixture was a solid pink color with no red streaks. The mixture was then placed under vacuum at room temperature for about 30 minutes to rid the mixture of any air bubbles. The mixture was then poured over the nickel master to make a negative impression of the light extraction structures. The mixture was allowed to stand for about 10 minutes to remove any air bubbles trapped at the nickel-silicone interface by pouring. The master and silicone mixture were then placed in an oven heated to about 65° C. for about 1.5 hours. Upon removal from the oven master and silicone mold were cooled for at least 10 minutes, then the silicone mold was removed from the nickel master.

### Preparation of a Polypropylene Mold

A nickel master was first prepared by electroforming a two photon master. The nickel master was positioned on a 8″×16″×¼″ (20×40×0.6 cm) sheet of polypropylene with the light extraction features facing the polypropylene sheet. The polypropylene sheet was placed on a ⅛″ (1.2 cm) thick aluminum sheet and the nickel master was covered from above w/a sheet of silicone coated polyester release liner. The sandwich construction was placed between two platens of a temperature controlled compression molding machine (Wabash MPI, Wabash, Ind.). The top and bottom platens in the molding machine were set to temperatures of 280° F. and 90° F. (138 and 32° C.) respectively. The pressure was incrementally increased to 10 tons (10.6 Mg) over 15 seconds and held at 10 tons (10.6 Mg) for 15 seconds. After release of the pressure, the sandwich construction was removed from the temperature controlled compression molding machine. The nickel mold was removed from the polypropylene sheet and the sheet was next placed between two layers of silicone treated polyester release liner and placed into a room temperature compression molding machine. A pressure of 2000 psi (13.79 MPa) was applied to the second layer construction for 10 minutes. The above process was repeated 6 times on the same piece of polypropylene in order to create a polypropylene mold with 6 identical extractor patterns in a 2×3 orientation. The polypropylene sheet was then fastened to a ⅛-inch (3.175 mm) thick aluminum plate using countersunk screws to eliminate any warp introduced into the polypropylene sheet during heating.

### Preparation of Polyurethane Light Guide

The silicone mold was then used to prepare a polyurethane light guide. About 75 g of type A polyurethane was placed in a beaker and put in a vacuum at about 55° C. for about 2 hours. Similarly, about 75 g of type B polyurethane was mixed with one drop (about 0.022 g) of dibutyl tin diacetate catalyst in a beaker, and the beaker placed in a vacuum at about 55° C. for about 2 hours. The polyurethanes were then transferred to separate MIXPAC 400 mL dispensing cartridges (ConProTec Inc., Salem, N.H.), the dispensing cartridges placed nozzle-down in a beaker and placed in a vacuum at about 55° C. for an additional hour.

The silicone mold was preheated to about 99° C. for at least one hour prior to casting the polyurethane light guide. The preheating expands the silicone so that it does not expand non-uniformly during the urethane curing exotherm. Non-uniform expansion would lower the fidelity of the urethane light guide to the desired geometry.

A double length of static mixer (MC 05-32, ConProTec Inc., Salem, N.H.) was attached to the end of the loaded MIXPAC cartridge to facilitate sufficient mixing of the two polyurethane precursors. After ensuring that the cartridge was free of bubbles, the uncured polyurethane resin was dispensed into the center of the mold cavity. The uncured polyurethane resin was covered with a release liner and the mold and placed in an oven at about 99° C. for about 5 minutes. The mold and cured polyurethane light guide were then removed from the oven and allowed to cool to room temperature over a time of about 5 to 10 minutes before removing the polyurethane light guide from the mold,

Preparation of Silicone Light Guide from Polypropylene Mold

Silicone light guides may be prepared from a polypropylene mold. About 1.1 g silicone was poured into the polypropylene mold, and a release liner was placed over the silicone. Any excess material was removed from the mold with a squeegee. The PP mold and silicone were placed under a 365 nm UV black light for about 10 minutes to effect cure of the silicone. Upon removal from the UV black light, the silicone was removed from the PP mold.

### Preparation of Urethane Acrylate Formulations

Two aliphatic polyester based urethane diacrylate oligomers (available as CN964 and CN965 from Sartomer Company, Inc., Exton, Pa.) were used along with a mono-functional acrylate (available as SR265 from Sartomer Company, Inc., Exton, Pa.), an antioxidant (available as IRGANOX 1076 from Ciba Specialty Chemicals, Tarrytown, N.Y.), and a photoinitiator (available as Lucerin TPO-L from BASF Chemical Company, Florham Park, N.J.). Twelve formulations were prepared as shown in Table I.

TABLE I

| | | | | | Irganox 1076 |
|---|---|---|---|---|---|
| Example | CN964 (g) | CN965 (g) | SR256 (g) | TPO-L (g) | (g) |
| 1 | 70 | — | 30 | 0.3 | 0.15 |
| 2 | 75 | — | 25 | 0.3 | 0.15 |
| 3 | 80 | — | 20 | 0.3 | 0.15 |
| 4 | 85 | — | 15 | 0.3 | 0.15 |
| 5 | 90 | — | 10 | 0.3 | 0.15 |
| 6 | 95 | — | 5 | 0.3 | 0.15 |
| 7 | — | 70 | 30 | 0.3 | 0.15 |
| 8 | — | 75 | 25 | 0.3 | 0.15 |
| 9 | — | 80 | 20 | 0.3 | 0.15 |
| 10 | — | 85 | 15 | 0.3 | 0.15 |
| 11 | — | 90 | 10 | 0.3 | 0.15 |
| 12 | — | 95 | 5 | 0.3 | 0.15 |

The twelve formulations were prepared by mixing appropriate amounts of each component in a Hauschild DAC 400FV(Z) (available from FlackTek Inc., Landrum S.C.) for two 4 minute mixing cycles at 2200 rpm. Each of the formulations was then degassed under a vacuum at about 70° C. for about 30 minutes, and were then used to prepare samples for tensile testing, DMA testing, refractive indices and tactile response testing.

### Preparation of Urethane Acrylate Light Guide

Light guide samples of various thicknesses were prepared using a polypropylene mold described above in Example 2. The PP mold was filled, covered with a cover sheet of non-release coated 0.005 inch (0.127 mm) polyethylene terephthalate (PET) film, and positioned under the bar of a knife coater. Light guide samples were prepared having various thicknesses between 190 and 700 μm. The resulting sandwich construction of PP tool/light guide coating/PET cover sheet was exposed to UV light using a Fusion Systems F300S with a mercury “H” bulb and LC-6 benchtop conveyor (Fusion UV Systems, Inc., Gaithersburg, Md.). Each laminate was placed on the conveyor belt at a speed of about 0.35 ft/sec (10.7 cm/sec) and passed under the lamp twice on each side of the laminate. After exposure, the light guide and PET cover sheet were removed from the PP mold as a laminate, and a release coated PET sheet was applied to the exposed light guide surface for protection. Individual light guide samples were then trimmed from the six-sample cluster using a CO₂ laser, leaving both PET films intact. Finally, individual light guide thickness measurements were performed for each sample preparation.

### Tensile Tests

Dogbone tensile specimens were prepared from each of the above formulations. First, 6 inch wide by 0.005 inch (127 μm) thick silicone coated PET release liners were placed under the bar of a knife coater with the gap between the bar and films set to 0.025 inches (623 μm). The top film was draped over the bar and a 50 gram amount of the desired formulation was placed directly behind and against the bar between the films. Both films were then pulled through the bar gap creating a laminate or sandwich construction. The laminates were cured by exposure to UV light from a Fusion Systems F300S with an “H” bulb and LC-6 benchtop conveyor (Fusion UV Systems, Inc., Gaithersburg, Md.). Each laminate was placed on the conveyor belt at a speed of about 0.35 ft/sec (10.67 cm/s) and passed under the lamp twice on each side of the laminate. Tensile specimens were cut from the cured laminates with a rule die fabricated to meet ASTM D638 Type IV dimensions. Tensile testing was performed on an Instron 5400 tensile testing machine (Instron Corp., Norwood, Mass.) set for an extension rate of 100% elongation per minute. Table II shows the average of 5 specimens for each Example.

TABLE II

| | Tensile | Yield | Yield | Break | Modulus of |
|---|---|---|---|---|---|
| | Strength | Stress | Elongation | Elongation | Elasticity |
| Ex. | (MPa) | (MPa) | (%) | (%) | (MPa) |
| 1 | 2.9 | 2.9 | 87.1 | 87.2 | 3.8 |
| 2 | 5.7 | 5.7 | 115.3 | 115.3 | 7.0 |
| 3 | 8.0 | 8.0 | 124.4 | 124.6 | 9.6 |
| 4 | 16.6 | 16.5 | 116.9 | 116.9 | 18.5 |
| 5 | 14.7 | — | — | 88.8 | 26.6 |
| 6 | 22.5 | — | — | 82.61 | 66.9 |
| 7 | 1.8 | 1.4 | 49.5 | 68.3 | 2.8 |
| 8 | 2.0 | 2.0 | 78.2 | 78.2 | 3.7 |
| 9 | 4.2 | 4.1 | 107.6 | 107.7 | 5.5 |
| 10 | 7.2 | 7.2 | 118.3 | 118.4 | 8.5 |
| 11 | 6.6 | 6.8 | 92.7 | 87.7 | 9.1 |
| 12 | 8.9 | — | — | 83.4 | 16.9 |

### Dynamic Mechanical Analysis Testing

Samples for dynamic mechanical analysis were prepared similarly to those used in tensile testing. Specifically, 6 inch (15.25 cm) wide by 0.005 inch (127 μm) thick silicone coated PET release liners were placed under the bar of a knife coater with the gap between the bar and films set to 0.025 inches (63.5 μm). The top film was draped over the bar and a 50 gram amount of the desired formulation was placed directly behind and against the bar between the films. Both films were then pulled through the bar gap creating a laminate or sandwich construction. The laminates were cured by exposure to UV light from a Fusion Systems F300S with an “H” bulb and LC-6 benchtop conveyor (Fusion UV Systems, Inc., Gaithersburg, Md.). Each laminate was placed on the conveyor belt at a speed of about 0.35 ft/sec (10.7 cm/sec) and passed under the lamp twice on each side of the laminate. Tensile specimens were then cut after removing the liners. A TA Q800 DMA machine was used in tensile mode with a frequency of 1 Hz, a maximum displacement of 15 μm, and a temperature range of −50° C. to +150° C. at a rise rate of 3° C./minute. The T_{g} was determined from the peak maximum of tan(δ) calculated from the measured elastic and inelastic components of the modulus, G′ and G″, respectively. The results are shown in Table III below.

TABLE III

| Example | Tg (° C.) |
|---|---|
| 1 | 7.6 |
| 2 | 16.2 |
| 3 | 23.1 |
| 4 | 33.2 |
| 5 | 34.2 |
| 6 | 42.4 |
| 7 | −4.3 |
| 8 | 2.7 |
| 9 | 13.8 |
| 10 | 21.8 |
| 11 | 27.3 |
| 12 | 36.1 |

### Tactile Responses

To test the tactile response and light extraction of the light guide samples, randomly selected light guide specimens were inserted into a cell phone assembly of popple, domesheet, light guide and keypad as described with respect to FIG. 4 above. Multiple keys were pressed to determine if sufficient contact could be made against the metal popple resulting in a depression and “click.” Tactile response was qualitatively measured using a rating system of 1-4, where 1=good, 2=marginal, 3=poor, and 4=none. As can be seen in Tables IV-XV, tactile response is a result of a combination of thickness and tensile modulus. The minimum thickness of the light guide is limited by the height of the light extraction structures, and the maximum thickness is limited by the total height allocated to the keypad assembly and the height of the other components in the keypad assembly. Based on the below data, it can been seen that acceptable light guide materials have a tensile modulus ranging from about 1 MPa to about 70 MPa, preferably about 1 MPa to about 20 MPa, and In some embodiments most preferably about 1 MPa to about 15 MPa. Additionally, it is apparent in some embodiments that acceptable light guide materials have a T_{g} between about −5° C. and about 45° C., preferably about 0° C. to about 30° C., most preferably between about 0° C. and about 20° C.

TABLE IV

| | | Tensile | | | |
|---|---|---|---|---|---|
| | Thickness | Modulus | Tg | Light | Tactile |
| Example | (μm) | (MPa) | (° C.) | Extraction | Response |
| 1 | 305 | 3.8 | 7.6 | yes | 1 |
| 1 | 307 | 3.8 | 7.6 | yes | 1 |
| 1 | 447 | 3.8 | 7.6 | yes | 1 |
| 1 | 457 | 3.8 | 7.6 | yes | 2 |
| 1 | 470 | 3.8 | 7.6 | yes | 1 |
| 1 | 483 | 3.8 | 7.6 | yes | 1 |
| 2 | 287 | 7 | 16.2 | yes | 1 |
| 2 | 290 | 7 | 16.2 | yes | 1 |
| 2 | 450 | 7 | 16.2 | yes | 2 |
| 2 | 452 | 7 | 16.2 | yes | 2 |
| 2 | 521 | 7 | 16.2 | yes | 4 |
| 2 | 531 | 7 | 16.2 | yes | 3 |
| 3 | 277 | 9.6 | 23.1 | yes | 1 |
| 3 | 290 | 9.6 | 23.1 | yes | 1 |
| 3 | 442 | 9.6 | 23.1 | yes | 3 |
| 3 | 475 | 9.6 | 23.1 | yes | 3 |
| 3 | 549 | 9.6 | 23.1 | yes | 4 |
| 3 | 554 | 9.6 | 23.1 | yes | 4 |

TABLE V

| | | Tensile | | | |
|---|---|---|---|---|---|
| | Thickness | Modulus | Tg | Light | Tactile |
| Example | (μm) | (MPa) | (° C.) | Extraction | Response |
| 4 | 333 | 18.5 | 33.2 | yes | 1 |
| 4 | 343 | 18.5 | 33.2 | yes | 1 |
| 4 | 472 | 18.5 | 33.2 | yes | 3 |
| 4 | 493 | 18.5 | 33.2 | yes | 4 |
| 4 | 556 | 18.5 | 33.2 | yes | 4 |
| 4 | 582 | 18.5 | 33.2 | yes | 4 |
| 5 | 411 | 26.6 | 34.2 | yes | 4 |
| 5 | 536 | 26.6 | 34.2 | yes | 4 |
| 5 | 302 | 26.6 | 34.2 | yes | 3 |
| 5 | 323 | 26.6 | 34.2 | yes | 3 |
| 5 | 417 | 26.6 | 34.2 | yes | 4 |
| 5 | 541 | 26.6 | 34.2 | yes | 4 |
| 6 | 325 | 66.9 | 42.4 | yes | 3 |
| 6 | 351 | 66.9 | 42.4 | yes | 3 |
| 6 | 472 | 66.9 | 42.4 | yes | 4 |
| 6 | 478 | 66.9 | 42.4 | yes | 4 |
| 6 | 478 | 66.9 | 42.4 | yes | 4 |
| 6 | 488 | 66.9 | 42.4 | yes | 4 |

TABLE VI

| | | Tensile | | | |
|---|---|---|---|---|---|
| | Thickness | Modulus | Tg | Light | Tactile |
| Example | (μm) | (MPa) | (° C.) | Extraction | Response |
| 7 | 262 | 2.8 | −4.3 | yes | 1 |
| 7 | 302 | 2.8 | −4.3 | yes | 1 |
| 7 | 437 | 2.8 | −4.3 | yes | 1 |
| 7 | 439 | 2.8 | −4.3 | yes | 1 |
| 7 | 518 | 2.8 | −4.3 | yes | 1 |
| 7 | 523 | 2.8 | −4.3 | yes | 1 |
| 8 | 300 | 3.7 | 2.7 | yes | 1 |
| 8 | 310 | 3.7 | 2.7 | yes | 1 |
| 8 | 467 | 3.7 | 2.7 | yes | 1 |
| 8 | 485 | 3.7 | 2.7 | yes | 1 |
| 8 | 495 | 3.7 | 2.7 | yes | 1 |
| 8 | 536 | 3.7 | 2.7 | yes | 1 |
| 9 | 274 | 5.5 | 13.8 | yes | 1 |
| 9 | 302 | 5.5 | 13.8 | yes | 1 |
| 9 | 452 | 5.5 | 13.8 | yes | 2 |
| 9 | 462 | 5.5 | 13.8 | yes | 2 |
| 9 | 462 | 5.5 | 13.8 | yes | 2 |
| 9 | 498 | 5.5 | 13.8 | yes | 2 |
| 10 | 277 | 8.5 | 21.8 | yes | 1 |
| 10 | 356 | 8.5 | 21.8 | yes | 1 |
| 10 | 373 | 8.5 | 21.8 | yes | 1 |
| 10 | 452 | 8.5 | 21.8 | yes | 1 |
| 10 | 503 | 8.5 | 21.8 | yes | 2 |
| 10 | 505 | 8.5 | 21.8 | yes | 2 |

TABLE VII

| | | Tensile | | | |
|---|---|---|---|---|---|
| | Thickness | Modulus | Tg | Light | Tactile |
| Example | (μm) | (MPa) | (° C.) | Extraction | Response |
| 11 | 330 | 9.1 | 27.3 | yes | 1 |
| 11 | 330 | 9.1 | 27.3 | yes | 1 |
| 11 | 455 | 9.1 | 27.3 | yes | 2 |
| 11 | 475 | 9.1 | 27.3 | yes | 2 |
| 11 | 531 | 9.1 | 27.3 | yes | 2 |
| 11 | 541 | 9.1 | 27.3 | yes | 2 |
| 12 | 295 | 16.9 | 36.1 | yes | 1 |
| 12 | 297 | 16.9 | 36.1 | yes | 1 |
| 12 | 417 | 16.9 | 36.1 | yes | 2 |
| 12 | 439 | 16.9 | 36.1 | yes | 2 |
| 12 | 531 | 16.9 | 36.1 | yes | 4 |
| 12 | 559 | 16.9 | 36.1 | yes | 4 |

### Examples 13-15

The formulations in these examples were made using the procedure described above in Example 6 except that the materials were varied as shown below in Table VIII. The materials used were: CN9009 aliphatic urethane acrylate oligomer, SR256-2(2-ethoxyethoxy)ethyl acrylate, SR230 diethylene glycol diacrylate, SR508 dipropylene glycol diacrylate, and SR268 tetraethylene glycol diacrylate. The CN965, CN9009, SR256, SR230, SR508, SR268 all were obtained from Sartomer Company, Inc., Exton, Pa. EBECRYL 4833 aliphatic urethane diacrylate was obtained from Cytec Surface Specialties Inc., Smyrna, Ga.

TABLE VIII
(Light Guide Material Formulations)

| | | | Ebecryl | | | | | | Irganox |
|---|---|---|---|---|---|---|---|---|---|
| Ex. | CN965 | CN9009 | 4833 | SR256 | SR230 | SR508 | SR268 | TPO-L | 1076 |
| 13 | — | 85 | — | 9 | 6 | — | — | 0.3 | 0.15 |
| 14 | — | 85 | — | 9 | — | 6 | — | 0.3 | 0.15 |
| 15 | — | — | 85 | 9 | — | — | 6 | 0.3 | 0.15 |

### Example 16

A methacrylate-functionalized acrylate oligomer (as described in US 2007-191506 “Curable Compositions for Optical Articles”) was transferred to a plastic mixing cup. An alkylene glycol oligomer with methacrylate functional groups on each end (Bisomer EP 100 DMA available from Cognis, Monheim, Germany) was added such that the weight ratio of acrylate oligomer to alkylene glycol oligomer was 64:36. As an antioxidant, 0.3 wt % octadecyl 3-(3,5-di-tert-butyl-4-hydroxyphenyl)propionate (Sigma-Aldrich, St. Louis, Mo.) was added, and 0.5 wt % photoinitiator (Lucerin TPO-L from BASF Chemical Co., Florham Park, N.J.) was added. The mixture was heated to 110° C. and mixed on a DAC 150 FV Speed Mixer (available from FlackTek Inc., Landrum S.C.) for 3 minutes.

### Example 17

Samples of a two-part epoxy (SCOTCHWELD DP-460NS, from 3M Company) were prepared using the 3M product dispensed and mixed from a DMA50 handheld dispensing gun. The following table of mechanical test result data was obtained following the procedures described above. In this table, “--” indicates that the property was not tested.

TABLE IX
(Mechanical Properties)

| | | | Modulus of Elasticity (MPa): | | | | |
|---|---|---|---|---|---|---|---|
| | Tensile | Break | Static | Dynamic | Dynamic | Dynamic | Dynamic |
| | Modulus | Elongation | Tensile | Tensile | Tensile | Bending | Bending |
| Ex. | (MPa) | (%) | at 23° C. | at 23° C. | at −30° C. | at 23° C. | at −30° C. |
| 8 | — | — | — | — | — | 52 | 2500 |
| 10 | 6 | 92 | 7 | 27 | 1913 | 45 | 2430 |
| 13 | 38 | 35 | 898 | 2223 | 3270 | 2200 | 3480 |
| 14 | 34 | 83 | 512 | 1830 | 2754 | 2500 | 3680 |
| 15 | 46 | 70 | 676 | 1256 | 2641 | 1560 | 3540 |
| 16 | 20 | 35 | 312 | 617 | 2160 | — | — |
| 17 | — | — | — | — | — | 2150 | 2870 |

The following table of Tg was obtained using the dynamic mechanical analysis (DMA) procedure described above. In this table, “--” indicates that the property was not tested.

TABLE X
(Tg ° C.)

| | Tg | Tg |
|---|---|---|
| Example | (tensile) | (bending) |
| 8 | 3 | 13 |
| 10 | 19 | 29 |
| 13 | 49 | 53 |
| 14 | 49 | 50 |
| 15 | 53 | 53 |
| 16 | 61 | — |
| 17 | — | 88 |

Various modifications and alterations to this invention will become apparent to those skilled in the art without departing from the scope and spirit of this invention. It should be understood that this invention is not to be unduly limited by the illustrative embodiments and examples set forth herein and that such examples and embodiments are presented by way of illustration and example, with the scope limited only by the claims set forth herein as follows. Each reference cited herein is incorporated by reference herein in its entirety.

We claim:

1. A flexible light guide comprising a material having a tensile modulus of from about 1 MPa to about 70 MPa at 23° C., an absorbance in the visible spectrum of less than about 0.0279 cm⁻¹, a refractive index of about 1.35 to about 1.65, and a thickness of from about 50 microns to about 700 microns, the light guide further comprising a plurality of light extraction structures.

2. The flexible light guide of claim 1, wherein the tensile modulus is from about 1 MPa to about 20 MPa at 23° C., the absorbance in the visible spectrum is less than about 0.0203 cm⁻¹, the refractive index is from about 1.4 to about 1.55, and the thickness is from about 50 microns to about 700 microns, the light guide further comprising a plurality of light extraction structures.

3. The flexible light guide of claim 1 wherein at least one of the plurality of light extraction structures comprises a depression.

4. A flexible light guide comprising a material having a dynamic bending modulus tensile modulus is from about 45 MPa to about 2500 MPa at 23° C., an absorbance of less than about 0.0132 cm⁻¹, a refractive index is about 1.45 to about 1.53, and a thickness of about 50 microns to about 700 microns, the light guide further comprising a plurality of light extraction structures.

5. The flexible light guide of claim 4, wherein at least one of the plurality of light extraction structures comprises a depression.

6. A device comprising:
a keypad; and
flexible light guide comprising a material having a tensile modulus of from about 1 MPa to about 70 MPa at 23° C., an absorbance in the visible spectrum of less than about 0.0279 cm⁻¹, a refractive index of about 1.35 to about 1.65, and a thickness of from about 50 microns to about 700 microns, the light guide further comprising a plurality of light extraction structures.

7. The device of claim 6, wherein at least one of the plurality of light extraction structures comprises a depression.

8. The device of claim 6, wherein the tensile modulus is from about 1 MPa to about 20 MPa at 23° C., the absorbance in the visible spectrum is less than about 0.0203 cm⁻¹, the refractive index is from about 1.4 to about 1.55, and the thickness is from about 50 microns to about 700 microns, the light guide further comprising a plurality of light extraction structures.

9. The device of claim 8, wherein at least one of the plurality of light extraction structures comprises a depression.

10. A method comprising:
providing a mold comprising a plurality of light extraction structures;
contacting an uncured resin comprising at least one of acrylate, urethane, silicone, urethane-acrylate functional groups; and
curing the uncured resin to form a flexible light guide comprising a plurality of light extraction structures and a tensile modulus of from about 1 MPa to about 70 MPa at 23° C., an absorbance in the visible spectrum of less than about 0.0279 cm⁻¹, a refractive index of about 1.35 to about 1.65, and a thickness of from about 50 microns to about 700 microns.

11. The method of claim 10, wherein the step of curing the uncured resin comprises curing the uncured resin to form a flexible light guide comprising a plurality of light extraction structures and a tensile modulus is from about 1 MPa to about 20 MPa at 23° C., the absorbance in the visible spectrum is less than about 0.0203 cm⁻¹, the refractive index is from about 1.4 to about 1.55, and the thickness is from about 50 microns to about 700 microns.

12. A flexible light guide comprising:
at least one acrylate, wherein the tensile modulus is from about 1 MPa to about 20 MPa at 23° C., the absorbance in the visible spectrum is less than about 0.0203 cm⁻¹, the refractive index is from about 1.4 to about 1.55, and the thickness is from about 50 microns to about 700 microns, the light guide further comprising a plurality of light extraction structures.

13. The flexible light guide of claim 12, wherein at least one of the plurality of light extraction structures comprises a depression.
